(19) United States
(12) Patent Application Publication
(10) Pub. No.: US 2023/0110375 A1
(43) Pub. Date: Apr. 13, 2023

(54) ROTATING DARK RIDE SYSTEMS AND METHODS

(71) Applicant: Oceaneering International, Inc., Houston, TX (US)

(72) Inventor: Clifford Allen Jennings, Highland, MD (US)

(73) Assignee: Oceaneering International, Inc., Houston, TX (US)

(21) Appl. No.: 17/963,628

(22) Filed: Oct. 11, 2022

Related U.S. Application Data
(60) Provisional application No. 63/254,409, filed on Oct. 11, 2021.

(51) Int. Cl. A63G 31/02; A63G 1/48

(52) U.S. Cl. CPC A63G 31/02; A63G 1/48

(57) ABSTRACT

An amusement ride experience may be provided using a ride system comprising a three-dimensional ride space; a predetermined set of motion-based vehicles; a turntable rotationally disposed at least partially within the three-dimensional ride space and operatively connected to the predetermined set of motion-based vehicles and configured to move each motion-base vehicle within two or more dimensions of the three-dimensional ride space without the use of track or vehicle-based propulsion; and a ride controller. The turntable and associated motion-based vehicles are installed in the three-dimensional ride space without using a track, track switches, track-related sensors, or trenching; a first motion-based vehicle positioned at a passenger loading position in the three-dimensional ride space; one or more passengers allowed to board the motion-based vehicle; the turntable used to rotate the motion-based vehicle to a predetermined set of locations within the three-dimensional ride space corresponding to a predetermined set of ride scenes, ending up with rotating the motion-based vehicle to passenger disembarkation position where the passenger exits the motion-based vehicle.

### RELATION TO OTHER APPLICATIONS

This application claims priority through U.S. Provisional Application 63/254,409 filed on Oct. 11, 2021.

### BACKGROUND

Dark ride systems can provide an immersive amusement ride experience but may also require a large amount of space and one or more tracks, track switches, track-related sensors or trenching. Some require use of “super-flat” flooring such as concrete. These can all add to the cost and complexity of providing a dark ride amusement ride experience.

### FIGURES

Various figures are included herein which illustrate aspects of embodiments of the disclosed inventions.

FIG. 1 is a top-down view of an exemplary ride system;

FIG. 2 is a view in partial perspective of an exemplary ride system;

FIG. 3 is a view in partial perspective of a portion of an exemplary ride system;

FIG. 4 is a view in partial perspective of an exemplary ride system;

FIG. 5 is a view in partial perspective of an exemplary ride system turntable and passenger vehicle arrangement;

FIG. 6 is a view in partial perspective of an exemplary ride system passenger vehicle arrangement;

FIG. 7 is a view in partial perspective of an exemplary ride system passenger vehicle motion assembly;

FIG. 8 is a view in partial perspective of an alternative exemplary ride system passenger vehicle motion assembly; and

FIG. 9 is a block diagram of an exemplary controller.

### DESCRIPTION OF EXEMPLARY EMBODIMENTS

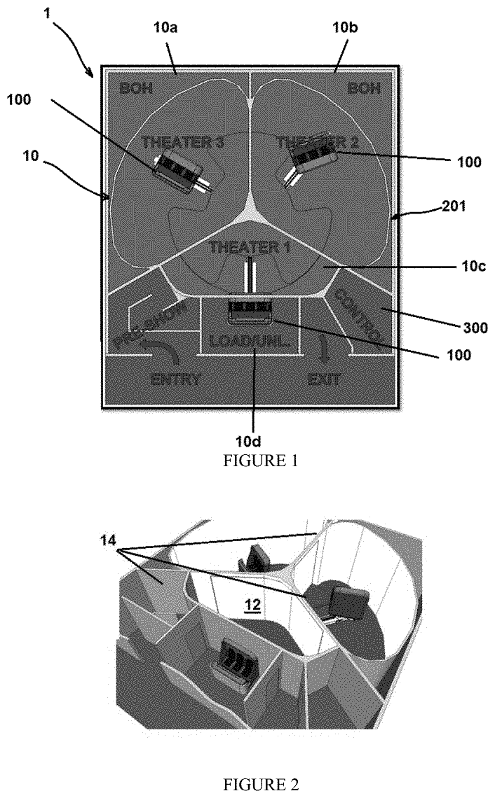

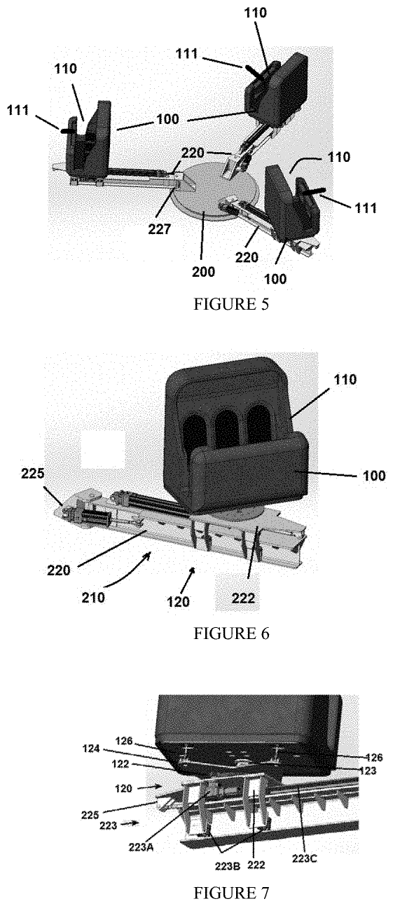

In a first embodiment, referring generally to FIG. 1, ride system 1 comprises three-dimensional ride space 10, generally effectively divided physically and/or functionally into two or more theater sections (e.g., 10a, 10b, 10c); a predetermined set of motion-based vehicles 100, typically a plurality of motion-base vehicles 100; turntable 200 (FIG. 5) rotationally disposed at least partially within three-dimensional ride space 10, typically at or near a center of ride space 10; and ride controller 300 operatively in communication with turntable 200 and with each motion-based vehicle 100 of the plurality of motion-based vehicles 100.

Three-dimensional ride space 10 does not require or use a track, track switches, track-related sensors, or trenching. Additionally, ride system 1 typically does not require the use of “super-flat” flooring such as concrete and may only require grouting and bolting via conventional installation means for turntable 200. In embodiments, the entire ride system 1 comprises a single central footing and bolt installation pattern.

Three-dimensional ride space 10 may comprise a two-dimensional area of around 40′×40′ (12.2 M×12.2 M) and at least partially contain lighting, projection, audio and other show elements related to an overall ride-show experience which may be configured to be installed separately from the predetermined set of motion-based vehicles 100 and turntable 200. Screens 12 (FIG. 2) and other scenic elements (not shown in the figures) may be installed after other ride system 1 components.

Although the predetermined set of motion-based vehicles 100 typically comprises a plurality of motion-base vehicles 100, in an embodiment a single motion-base vehicle 100 may be used and inserted back and forth between load/unload area 10d and one or more dedicated show areas, e.g., 10a, 10b, 10c. In any embodiment, each motion-base vehicle 100 comprises one or more passenger-carrying compartments 110 (FIG. 5) and motion platform 120 (FIG. 7) operatively connected to passenger-carrying compartment 100.

Referring additionally to FIG. 5, passenger-carrying compartment 110 may comprise an excursion for passenger-carrying compartment 110, and possibly its associated motion platform 120 (FIG. 7), of sufficient length to push it towards or away from a center of turntable 200. In these embodiments, passengers may be thrust toward or away from story graphics projected on central screen 12 (FIG. 2) associated with that motion-based vehicle 100. In addition, scenic treatment of the interface, e.g., screen 12, can make passenger-carrying compartment 110 appear to be part of a much larger vehicle, such as an escape pod within a large spacecraft, as viewed before loading and after unloading.

Typically, passenger-carrying compartment 110 comprises accommodations for between 8 and 12 passengers. In certain embodiments, motion-base vehicle 100 comprises more than one story, e.g., two or more separate and stacked or otherwise offset passenger-carrying compartments 110. In further embodiments, passenger-carrying compartment 110 comprises a predominantly enclosed cabin which may further comprise a predetermined set of selectively obscurable windows operatively in communication with ride controller 300 (FIG. 1) such that a change in a setting may be revealed by selectively making one or more of the obscurable windows transparent and/or opaque or cycling between the two.

Referring now to FIG. 6 and FIG. 7, in typical embodiments motion platform 120 comprises mechanical rotator or motion translator 122, passenger cabin carrier 222, and motion platform actuator 223. Motion platform actuator 223 may comprise motor 223A operatively in communication with beam 220 such as with wheels 223B and a cog/tooth mechanism 223C or the like such as a worm screw or chain.

Referring still to FIG. 7, in typical embodiments motion platform 120 further comprises motion platform base 124 and a set of motion platform freedom actuators 126 disposed intermediate, and operatively connected to, motion platform base 124 and passenger-carrying compartment 110. Motion platform freedom actuators 126 are operative to move passenger-carrying compartment 110 directly or indirectly in or through one or more of a plurality of degrees of freedom, e.g., yaw, pitch, roll, heave, and surge. Yaw functions may be used to turn motion-base vehicles 100 ninety degrees (90°) or more during surge translation, thus achieving a left or right side-sway effect. Motion platform freedom actuator 126 may be disposed intermediate, and operatively connected to, passenger-carrying compartment 110 and motion platform base 124. In most embodiments, motion platform base 124 may also comprise mechanical rotator or motion translator 122.

Cabin pivot join 123 may also be present and disposed intermediate passenger cabin carrier 222 or motion platform base 124 and a central portion of passenger-carrying compartment 110 to aid in motion translation.

Referring back to FIG. 1, turntable 200 is operatively connected to the predetermined set of motion-based vehicles 100 and configured to move each motion-base vehicle 100 of the predetermined set of motion-based vehicles 100 within at least two dimensions of three-dimensional ride space 10 without the use of track or vehicle-based propulsion. Turntable 200 may comprise rotating outer ring 201, comprising or otherwise operatively connected to a plurality of motion-based vehicles 100 and a corresponding plurality of beams 220 (FIG. 5).

Turntable 200 typically comprises or defines a first location within three-dimensional ride space, e.g., at or proximate theater section such as load/unload area 10d, where the first location allows sequentially bringing each motion-based vehicle 100 to load/unload area 10d for sequential passenger boarding of one or more passengers onto, or passenger disembarkation of one or more passengers from, motion-base vehicle 100 and a predetermined set of further locations, e.g., at or proximate 10a, 10b, and 10c, each further location 10a, 10b, 10c corresponding to and defining, at least in part, a show space of a predetermined set of show spaces within three-dimensional ride space 10. The predetermined set of show spaces within three-dimensional ride space 10 typically comprises a plurality of show spaces within three-dimensional ride space 10, each typically related to a location 10a, 10b, 10c of a corresponding set of further locations 10a, 10b, 10c and each show space typically comprises one or more scenes, i.e., visuals, associated with that show space.

Referring back to FIG. 5 and FIG. 6, in embodiments turntable 200 further comprises a set of beams 220, each beam 200 operatively connected at an end of beam 200 to turntable 200, such as at pivot joint 227, and corresponding to and associated with a motion-based vehicle 100 of the predetermined set of motion-based vehicles 100, where each motion vehicle 100 is bidirectionally and slidingly in communication with its corresponding beam 220, and a set of motion platform actuators 223 (FIG. 7), where each motion platform actuator 223 is operatively connected to a motion-based vehicle 100 and operatively in communication with its associated beam 220 of the set of beams 220 to move its associated motion-based vehicle 100 along its associated beam 220.

In embodiments, beam 210 comprises pivot joint 227 (FIG. 5) disposed in-between beam 220 and turntable 200 and configured to allow movement of its associated beam 200 in one or more planes. In these embodiments, in addition to passenger-carrying compartment 110 having independent yaw and surge translation, beam 220 may pivot at its pivot joint 227 with turntable 200 in one or more planes to provide additional movement of passenger-carrying compartment 110. With motion vehicle 100 oriented at ninety degrees (90°) to its translation beam, this pivoting of beam 220 may impart thrust in two or more directions. In conjunction with yaw and surge, pivoting about pivot joint 227 allows motion vehicle 100 to move dramatically within the scene space it presently occupies. Beam 210 may further comprise independent yaw and surge translator 225 disposed at a second of beam 210 away from turntable 200.

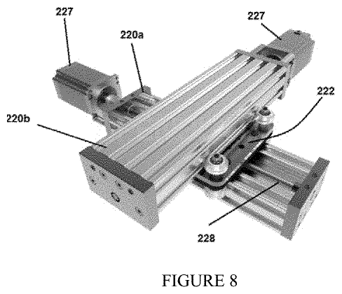

Referring additionally to FIG. 8, in alternate embodiments, beam-pivoting and beam-traversing functions may be replaced with an X-Y means of bi-directional translation, e.g., an X-Y table able to move passenger-carrying compartment 110 by not using pivot joint 227, or not providing it all, and, instead, fixing beam 220 to turntable 200, in embodiments using second beam 220b. Additional passenger cabin carrier 222 runs exist on one or a plurality of transverse beams 220a, 220b towards or away from turntable 200. In this embodiment, passenger cabin carrier 222 now moves left/right on transverse beams 220a, 220b. Movement may be accomplished by equivalent means such as by using motor 227 and worm screw 228 or the like.

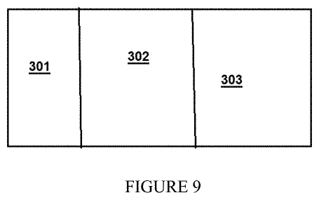

In most embodiments, referring to FIG. 9, controller 300 may be operatively in communication with turntable 200 via wired and/or wireless data communication and comprises turntable controller 301 configured to control rotation of turntable 200 synchronously with an overall show sequence; motion platform controller 302 configured to control each motion platform 120 attached to a corresponding passenger-carrying compartment 110, and experience controller 303 configured to control lighting, projection, audio and other show elements related to an overall ride-show experience. Audio, lighting, projection and other resources may be shared between scenes.

In the operation of exemplary methods, referring back to FIG. 1, an amusement ride experience may be provided using ride system 1, which is as described above.

Turntable 200 and its associated motion-based vehicles 100 are installed in three-dimensional ride space 10 without using a track, track switches, track-related sensors, or trenching. A first motion-based vehicle 100 is positioned at or proximate passenger load/unload area 10d and one or more passengers allowed to board motion-based vehicle 100. Turntable 200 then rotates motion-based vehicle 100 to and through a predetermined set of predetermined locations 10a, 10b, 10c within ride space 10, where each predetermined location 10a, 10b, 10c corresponds to a predetermined ride scene. After sequencing through three-dimensional ride space 10, turntable 200 rotates motion-based vehicle 100 back to a passenger disembarkation load/unload area 10d and the passenger(s) are allowed to exit motion-based vehicle 100.

In embodiments, unload/load area 10d comprises its own scene, in which case passenger-carrying compartment 110 may comprise an excursion of sufficient length to permit insertion of passenger-carrying compartment 110 into surrounding station platform and scenery of unload/load area 10d.

Where turntable 200 further comprises a set of motion platform freedom actuators 126 operative to move passenger-carrying compartment 110 in or through a plurality of degrees of freedom, motion platform freedom actuators 126 may be used to move passenger-carrying compartment 110 in or through a predetermined set of degrees of freedom associated with predetermined ride scene. This movement in the predetermined set of degrees of freedom may be used to allow motion-based vehicle 100 to move about and/or within each scene while being simultaneously affected by, e.g., pitch, roll, and/or yaw.

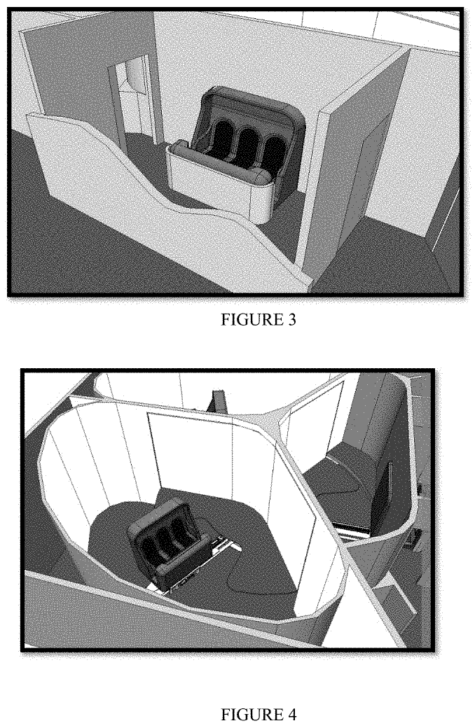

Typically, referring additionally to FIG. 2, the predetermined set of locations 10a, 10b, 10c within three-dimensional ride space 10 comprises or otherwise defines a plurality of locations (e.g., 10a, 10b, 10c) within three-dimensional ride space 10 and the predetermined set of motion-based vehicles 100 comprises a plurality of associated motion-based vehicles 100, each motion-based vehicle 100 disposed within three-dimensional ride space 10 with central screen 12 and a set of dividing walls 14 to isolate each motion-based vehicle 100 from other motion-based vehicles 100 of the predetermined set of motion-based vehicles 100. In this embodiment, referring generally to FIG. 3 and FIG. 4, motion-based vehicles 100 may be moved within three-dimensional ride space 100 with their associated passenger(s) from scene to scene, typically without passengers realizing it, by facing passenger-carrying compartment 110 associated with the passenger(s) to its associated central screen 12, rotating motion-based vehicle 100 with its respective central screen 12 and dividing walls 14 to a next position within three-dimensional ride space 10, and moving motion-based vehicle 100 in one or more of several degrees of freedom, e.g., yaw, to face a perimeter of a newly-entered scene. Each scene can have different static scenic elements (not shown in the figures) mounted in front of a main perimeter screen, e.g., 12, and actions and/or scenes projected thereon.

Typically, the predetermined set of locations 10a, 10b, 10c within three-dimensional ride space 10 and the corresponding predetermined ride scenes are dynamically programmable and may be programmed to provide multiple shows at any given time, without disruption of the mechanical system. In certain embodiments, one or more passengers in passenger-carrying compartment 110 may be permitted to select which show is to be experienced, e.g., using one or more input devices 111 (FIG. 5) associated with passenger-carrying compartment 110.

The foregoing disclosure and description of the inventions are illustrative and explanatory. Various changes in the size, shape, and materials, as well as in the details of the illustrative construction and/or an illustrative method may be made without departing from the spirit of the invention.

1. A ride system, comprising:
a) a three-dimensional ride space;
b) a predetermined set of motion-based vehicles, each motion-base vehicle comprising:
i) a passenger-carrying compartment; and
ii) a motion platform operatively connected to the passenger-carrying compartment;
c) a turntable rotationally disposed at least partially within the three-dimensional ride space, the turntable operatively connected to the predetermined set of motion-based vehicles and configured to move each motion-based vehicle of the predetermined set of motion-based vehicles within two dimensions of the three-dimensional ride space without the use of track or vehicle-based propulsion; and
d) a ride controller operatively in communication with the turntable and each motion-based vehicle of the plurality of motion-based vehicles.

2. The ride system of claim 1, wherein the three-dimensional ride space does not require track, track switches, track-related sensors or trenching.

3. The ride system of claim 1, wherein the motion platform comprises a mechanical rotator or a motion translator.

4. The ride system of claim 1, wherein the motion platform further comprises a set of motion platform freedom actuators operative to move the passenger-carrying compartment through a plurality of degrees of freedom.

5. The ride system of claim 1, wherein the turntable comprises:
a) a first location within the three-dimensional ride space, the first location comprising a load/unload area for sequential passenger boarding onto, or passenger disembarkation from, a motion-base vehicle of the predetermined set of motion-based vehicles; and
b) a predetermined set of second locations corresponding to a predetermined set of show spaces within the three-dimensional ride space.

6. The ride system of claim 1, wherein the turntable further comprises:
a) a set of beams corresponding to the predetermined set of motion-based vehicles, each beam connected to the turntable at a first end of each beam, each motion-based vehicle's motion platform bidirectionally slidingly in communication with its corresponding beam; and
b) the motion platform comprises a set of motion platform actuators, each motion platform actuator operatively in communication with an associated beam of the set of beams and operative to move the motion platform along its associated beam.

7. The ride system of claim 6, wherein the motion platform further comprises:
a) a motion platform base;
b) a passenger-carrying compartment carrier;
c) a set of motion platform freedom actuators disposed intermediate the motion platform base and the passenger-carrying compartment and operative to move the passenger-carrying compartment through a plurality of degrees of freedom; and
d) a cabin pivot joint disposed intermediate the passenger-carrying compartment carrier or the motion platform base and a central portion of passenger-carrying compartment.

8. The ride system of claim 1, wherein the passenger-carrying compartment comprises an excursion for the passenger-carrying compartment and its motion platform base of sufficient length to push it towards or away from a center of the turntable.

9. The ride system of claim 1, wherein the entire ride system comprises a single central footing and bolt installation pattern.

10. The ride system of claim 1, wherein the motion-based vehicle comprises more than one story.

11. The ride system of claim 1, wherein the turntable comprises:
a) a rotating outer ring, comprising a predetermined set of beams, each motion-based vehicle operatively in communication with a beam of the predetermined set of beams; and
b) a corresponding plurality of motion-base motion-based vehicle motion actuators.

12. The ride system of claim 1, wherein the passenger-carrying compartment comprises a predominantly enclosed cabin.

13. The ride system of claim 12, wherein the predominantly enclosed cabin comprises a predetermined set of selectively obscurable windows operatively in communication with the ride controller.

14. A method for providing an amusement ride experience using a ride system comprising a three-dimensional ride space, a predetermined set of motion-based vehicles, each motion-base vehicle comprising a passenger-carrying compartment and a motion platform operatively connected to the passenger-carrying compartment; a turntable rotationally disposed at least partially within the three-dimensional ride space where the turntable is operatively connected to the predetermined set of motion-based vehicles and configured to move each motion-base vehicle of the predetermined set of motion-based vehicles within two dimensions of the three-dimensional ride space without the use of track or vehicle-based propulsion, and a ride controller operatively in communication with the turntable and each motion-based vehicle of the plurality of motion-based vehicles, the method comprising:
a) installing the turntable and the predetermined set of motion-based vehicles in the three-dimensional ride space without using a track, track switches, track-related sensors, or trenching;
b) positioning a first motion-based vehicle of the predetermined set of motion-based vehicles at a passenger load/unload area in the three-dimensional ride space;
c) allowing a passenger to board the first motion-based vehicle;
d) using the turntable to rotate the first motion-based vehicle through a predetermined set of locations within the three-dimensional ride space, each location of the predetermined set of locations corresponding to a predetermined ride scene;
e) using the turntable to rotate the first motion-based vehicle to passenger load/unload area in the three-dimensional ride space for disembarkation; and
f) allowing a passenger to exit the first motion-based vehicle.

15. The method of claim 14, wherein the motion platform further comprises a set of motion platform freedom actuators operative to move the passenger-carrying compartment through a plurality of degrees of freedom, the method further comprising using the set of motion platform freedom actuators to move the passenger-carrying compartment through a predetermined set of a plurality of degrees of freedom associated with the predetermined ride scene.

16. The method of claim 15, wherein the movement in the predetermined set of the plurality of degrees of freedom allows the first motion-based vehicle to move within each scene while being simultaneously affected by pitch, roll and yaw.

17. The method for the ride system of claim 14, wherein the three-dimensional ride space further comprises an unload/load scene, the method further comprising configuring the passenger-carrying compartment to comprise an excursion for the passenger-carrying compartment of sufficient length to permit insertion of the passenger-carrying compartment into surrounding station platform and scenery of the unload/load area.

18. The method for the ride system of claim 14, wherein:
a) the predetermined set of locations within the three-dimensional ride space comprises a plurality of locations within the three-dimensional ride space;
b) the predetermined set of motion-based vehicles comprises a plurality of motion-based vehicles;
c) each motion-based vehicle is disposed within the three-dimensional ride space that further comprises a central screen and a set of dividing walls to isolate that motion-based vehicle from the other motion-based vehicles; and
d) the method further comprising moving the motion-based vehicles within the three-dimensional ride space with the passenger moved from scene to scene without realizing it by:
i) facing the passenger-carrying compartment associated with the passenger to an associated central screen;
ii) rotating the motion-based vehicle with its associated central screen and set of dividing walls to a next position within the three-dimensional ride space; and
iii) yawing the motion-based vehicle to face a perimeter of a newly-entered scene.

19. The method for the ride system of claim 14, wherein the predetermined set of locations within the three-dimensional ride space and the corresponding predetermined ride scenes are dynamically programmable.

20. The method for the ride system of claim 19, wherein:
a) the predetermined set of locations within the three-dimensional ride space and the corresponding predetermined ride scenes are programmed to provide multiple shows at any given time; and
b) a passenger is permitted to select which show is to be experienced by that passenger.
